(19) United States
(12) Patent Application Publication
(10) Pub. No.: US 2025/0129811 A1
(43) Pub. Date: Apr. 24, 2025

(54) WELDMENT ASSEMBLY

(71) Applicant: GM Global Technology Operations LLC, Detroit, MI (US)

(72) Inventors: Ying Lu, Novi, MI (US); Junjie Ma, Novi, MI (US); Hui-Ping Wang, Troy, MI (US); Mitchell Poirier, Owosso, MI (US); Scott A. Hooker, Sterling Heights, MI (US)

(73) Assignee: GM Global Technology Operations LLC, Detroit, MI (US)

(21) Appl. No.: 18/493,722

(22) Filed: Oct. 24, 2023

(51) Int. Cl. F16B 5/08

(52) U.S. Cl. CPC F16B 5/08

(57) ABSTRACT

A weldment assembly includes a first component and a second component configured to be coupled to the first component. Additionally, the first component and the second component are coupled through a first linear stitch and a second linear stitch disposed parallel to the first linear stitch.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a weldment assembly.

Welding is often used to join multiple components. There are many different welding techniques and joint types resulting is varying weld geometries. One popular welding geometry is a staple weld, which includes arced regions on either side of a linear weld to provide additional strength to the welded assembly. Because the arced regions provide additional strength, smaller staple welds may be used to join components, which allows for smaller components to be coupled securely.

However, during the welding process, heat accumulates in the arc regions of the staple weld, which can lead to welding process instability in the arc regions. Therefore, a need remains for an improved weldment assembly that provides additional strength but avoids the instability issues.

### SUMMARY

In some examples, a weldment assembly includes a first component and a second component configured to be coupled to the first component. Additionally, the first component and the second component are coupled through a first linear stitch and a second linear stitch disposed parallel to the first linear stitch. In some examples, the first linear stitch and the second linear stitch are disposed approximately 5-20 mm apart. In some examples, the first linear stitch and the second linear stitch are disposed approximately 5-12.5 mm apart. In some examples, the first linear stitch and the second linear stitch are vertical stitches. In some examples, the first linear stitch and the second linear stitch are horizontal stitches. In some examples, the first linear stitch is linearly offset from the second linear stitch. In some examples, the length of the first linear stitch is approximately 20-25 mm. In some examples, the length of the second linear stitch is approximately 20-25 mm. Additionally, in some examples a vehicle may incorporate the weldment assembly.

In some examples, a weldment assembly includes a first component and a second component configured to be coupled to the first component. Additionally, the first component and the second component are coupled through a first linear stitch and a second linear stitch. In some examples, the first linear stitch extends in a first direction past the second linear stitch and wherein the second linear stitch extends in a second direction past the first linear stitch, and wherein the first direction is opposite the second direction. In some examples, the first linear stitch and the second linear stitch are disposed approximately 5-20 mm apart. In some examples, the first linear stitch and the second linear stitch are disposed approximately 5-12.5 mm apart. In some examples, the first linear stitch and the second linear stitch are vertical stitches. In some examples, the first linear stitch and the second linear stitch are horizontal stitches. In some examples, the length of the first linear stitch and a length of the second linear stitch are the same. In some examples, a vehicle incorporates the weldment assembly.

In some examples, a weldment assembly forming a component for a vehicle includes a first component and a second component configured to be coupled to the first component. Additionally, the first component and the second component are coupled through a first linear stitch and a second linear stitch disposed parallel to the first linear stich, with the first linear stitch and the second linear stitch disposed approximately 5-20 mm apart from one another. Moreover, the first linear stitch is formed in a first direction and the second linear stitch is formed in a second direction, with the first direction being opposite the second direction. Additionally, the first component and the second component are coupled through a welding process, with the welding process being one or more of a fusion welding process, a laser beam welding process, an electron beam welding process, a solid-state welding process, a friction stir welding process, and an adhesive bonding process. Moreover, in some examples, the first linear stitch and the second linear stitch are vertical stitches. Additionally, the first linear stitch and the second linear stitch are horizontal stitches. In some examples, a vehicle incorporates the weldment assembly.

### BRIEF DESCRIPTION OF THE DRAWINGS

The drawings described herein are for illustrative purposes only of selected configurations and are not intended to limit the scope of the present disclosure.

FIG. 1 is an exterior view of a vehicle having at least one component including a weldment assembly as described herein:

FIG. 2A is an exploded view of a first portion and a second portion of a weldment assembly in accordance with the principles of the present disclosure prior to coupling:

FIG. 2B is a perspective view of one example of a weldment assembly in accordance with the principles of the present disclosure:

FIG. 3 is a top plan view of the weldment assembly of FIG. 2B; and

FIG. 4 is a top plan view of another example of a weldment assembly in accordance with the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises.” “comprising.” “including,” and “having.” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first.” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC): a digital, analog, or mixed analog/digital discrete circuit: a digital, analog, or mixed analog/digital integrated circuit: a combinational logic circuit: a field programmable gate array (FPGA): a processor (shared, dedicated, or group) that executes code: memory (shared, dedicated, or group) that stores code executed by a processor: other suitable hardware components that provide the described functionality: or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's client device in response to requests received from the web browser.

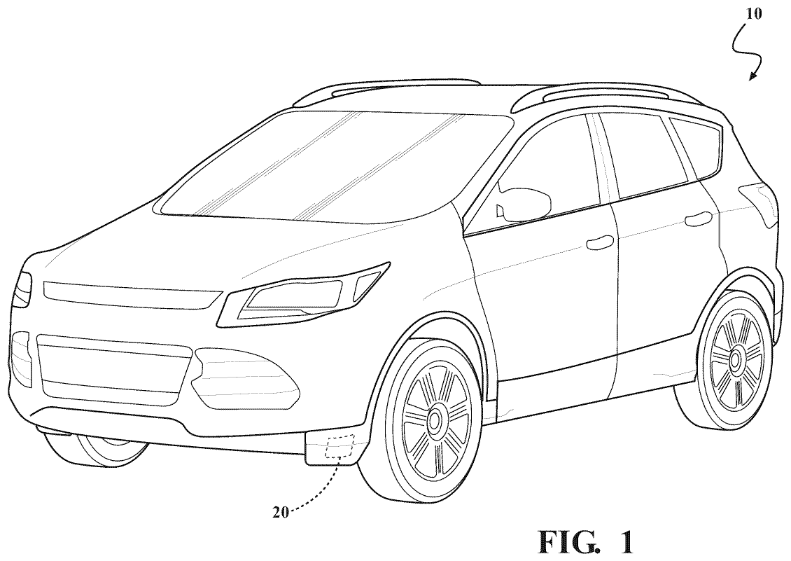

Referring now to the examples illustrated in FIGS. 1-4, a weldment assembly is generally illustrated at 20. In the example shown in FIG. 1, the weldment assembly 20 is incorporated into an electric vehicle 10. While the weldment assembly 20 is shown as being incorporated into an electric vehicle 10, the weldment assembly 20 could be incorporated into other types of vehicles such as vehicles having internal combustion engine capabilities, hybrid vehicles including both electric and internal combustion engine capabilities, water vehicles, or air vehicles. Additionally, the weldment assembly 20 and method as described herein can be applied to any joinable components and/or materials including for vehicle components and subcomponents. Further, the weldment assembly 20 may also be used in non-vehicle applications such as, for example, robotics, telescopes, turbines, golf clubs, tools, or the like.

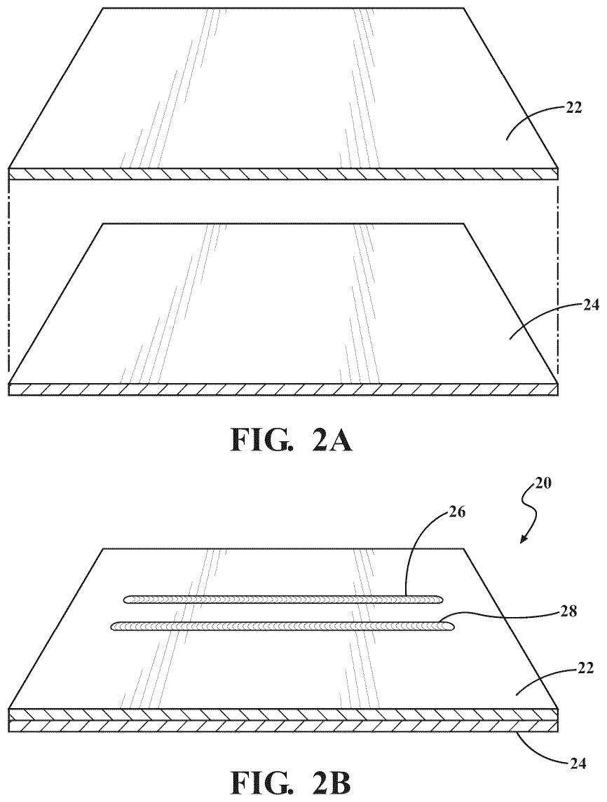

As best illustrated in the example shown in FIG. 2A, the weldment assembly 20 includes a first component 22 and a second component 24. The first component 22 is a sheet of material with a generally planar shape. In the example shown, the first component 22 has four sides all having approximately the same length. However, is it contemplated that the first component 22 may any shape and/or size. Additionally, in the examples shown, the first component 22 has a thickness of approximately 0.5-7 mm. In some examples, the thickness of the first component 22 is approximately 0.7-3 mm. Additionally, in some examples, the thickness of the first component 22 is approximately 1 mm. However, various other thickness have been contemplated. Additionally, in the example shown, the first component 22 may be comprised of a high-strength steel material including, but not limited to, a hot dip galvanized coated steel material. However, it is contemplated that the first component 22 may be comprised of any metallic material including, but not limited to, any type of steel, aluminum alloys, copper, nickel, magnesium alloys, and polymers and may or may not include a coating thereon. In one configuration, the first component 22 may be a flange portion or other portion of a larger system or component.

Referring still to the example shown in FIG. 2A, the second component 24 may be a sheet of material with a generally planar shape. In the example shown, the second component 24 has four sides all having approximately the same length. However, is it contemplated that the second component 24 may any shape and/or size. In one configuration, the second component 24 has a thickness of approximately 0.5-7 mm. In some examples, the thickness of the second component 24 is approximately 0.7-3 mm. Additionally, in some examples, the thickness of the second component 24 is approximately 1 mm. However, various other thickness have been contemplated. Additionally, in the example shown, the second component 24 may be comprised of a high-strength steel material, such as a hot dip galvanized coated steel material. However, it is contemplated that the second component 24 may be comprised of any metallic material including, but not limited to, any type of steel, aluminum alloys, copper, nickel, magnesium alloys, and polymers and may or may not include a coating thereon. In one configuration, the second component 24 may be a flange portion or other portion of a larger system or component.

In some examples, the first component 22 and the second component 24 are the same size and shape. However, it is contemplated that the first component 22 and the second component 24 may be different sizes and/or shapes from one another. Additionally, in some examples, the first component 22 and the second component 24 have the same thickness as one another. However, it is also contemplated that the first component 22 and the second component 24 may have different thickness from one another. Moreover, in some examples, the first component 22 and the second component 24 are comprised of the same material. However, it is also contemplated that the first component 22 and the second component 24 may be comprised of different materials.

As best illustrated in FIG. 2B the first component 22 and the second component 24 are configured to be coupled together through a welding process. In some examples, the weld may be made through a fusion welding process, such as a laser welding process and/or an electron beam welding process, a solid-state welding process such as a friction stir welding process, and an adhesive bonding process. However, various other welding processes have been contemplated. The welding process requires a welding tool to form the weld. In some examples, the welding tool is a laser welder. However, is it also contemplated that the welding tool may be another type of welding tool including, but not limited to, an arc welding tool, a gas tungsten arc welding tool, a flash welding tool, and a metal inert gas welding tool.

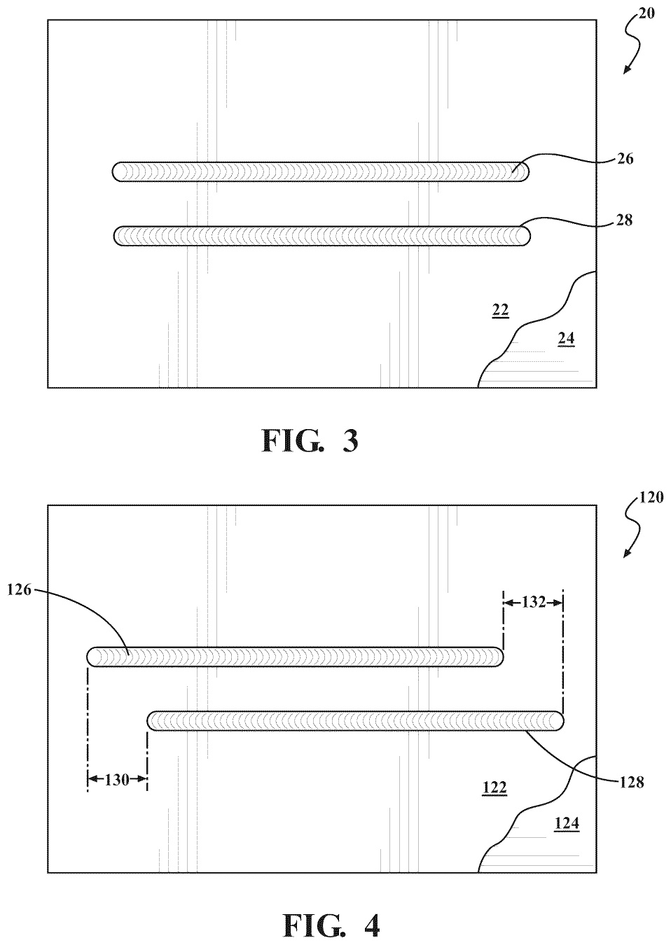

More specifically, referring now to the example shown in FIGS. 2B and 3, the first component 22 and the second component 24 are configured to be coupled together using a first linear stitch 26 and a second linear stitch 28 made by the welding tool. The first linear stitch 26 is generally linear and may be a vertical stitch or a horizontal stitch, relative to the joint of the first component 22 and the second component 24. In the example shown, the first linear stitch 26 is configured to have similar dimensions to a standard staple weld of approximately 20 mm. However, in some examples, the length of the first linear stitch 26 is approximately 10-35 mm. Additionally, in some examples, the first linear stitch 26 is approximately 15-30 mm. Additionally, in some examples, the first linear stitch 26 is approximately 20-25 mm. It is also contemplated that the first linear stitch 26 may be of any size to correspond with a desired strength.

Referring still to the example shown in FIGS. 2B and 3, the second linear stitch 28 is similar to the first linear stitch 26 and is generally linear. Additionally, the second linear stitch 28 may be a vertical stitch or a horizontal stitch, relative to the joint of the first component 22 and the second component 24. In the example shown, the second linear stitch 28 is configured to have similar dimensions to a standard staple weld of approximately 20 mm. However, in some examples, the length of the second linear stitch 28 is approximately 10-35 mm. Additionally, in some examples, the second linear stitch 28 is approximately 15-30 mm. Additionally, in some examples, the second linear stitch 28 is approximately 20-25 mm. It is also contemplated that the second linear stitch 28 may be of any size to correspond with a desired strength.

In some examples, the first linear stitch 26 and the second linear stitch 28 are the same length and/or width. However, it is also contemplated that the first linear stitch 26 and the second linear stitch 28 may be a different length and/or width from one another. Additionally, in the example shown, the first linear stitch 26 and the second linear stitch 28 start and end at the same location. For example, in the example shown where the first linear stitch 26 and the second linear stitch 28 are horizontal stitches, the first linear stitch 26 and the second linear stitch 28 begin at the same horizontal location as one another and have the same length such that they also end at the same horizontal location as one another.

Referring still to the example shown in FIGS. 2B and 3, the first linear stich and the second linear stitch 28 may be disposed parallel to one another. In the example shown, the first linear stitch 26 and the second linear stich 28 are disposed approximately 5 mm apart from one another. However, in some examples, the first linear stitch 26 and the second linear stitch 28 are disposed approximately 5-12.5 mm apart. In some examples, the first linear stitch 26 and the second linear stitch 28 are disposed approximately 5-20 mm apart. Moreover, in some examples, the distance between the first linear stitch 26 and the second linear stitch 28 is approximately 20%-50% of one of the length of the first linear stitch 26 or the second linear stich 28.

Referring now to the example shown in FIG. 4, another example of a weldment assembly 120 is shown. The weldment assembly 120 as shown in FIG. 4 also includes a first component 122 and a second component 124 configured to be coupled to one another through a first linear stitch 126 and a second linear stitch 128. The first component 122 and the second component 124 may be similar to the first component 22 and the second component 24, respectively. Additionally, in the example shown in FIG. 4, the first linear stitch 126 and the second linear stitch 128 are disposed parallel to one another at a distance similar to the first linear stitch 26 and the second linear stitch 28. However, in the example shown in FIG. 4, the first linear stitch 126 extends in a first direction past the second linear stitch 128. The first direction may be a linear direction in which the first linear stitch 126 extends. In some examples, a portion of the first linear stitch 126 that extends past the second linear stitch 128 is known as a power ramping down region 130. In some examples, the power ramping down region 130 has a length of approximately 3.5 mm. However, in some examples, the power ramping down region 130 has a length of approximately 3-5 mm. In other examples, the power ramping down region 130 has a length of approximately 2-7 mm. In some examples, the power ramping down region 130 has a length of approximately 1-9 mm.

Additionally and/or alternatively, in the example shown, the second linear stitch 128 extends in a second direction past the first linear stitch 126, defined as a power ramping down region 132 of the second linear stitch 128. The second direction may be a linear direction in which the second linear stitch 128 extends, and opposite the first direction. In the example shown, the power ramping down region 130 of the first linear stitch 126 and the power ramping down region 132 of the second linear stitch 128 extend in opposite linear directions. In some examples, the power ramping down region 132 has a length of approximately 3.5 mm. However, in some examples, the power ramping down region 132 has a length of approximately 3-5 mm. In other examples, the power ramping down region 132 has a length of approximately 2-7 mm. In some examples, the power ramping down region 132 has a length of approximately 1-9 mm. Regardless of the particular length of the power ramping down region 130 and the power ramping down region 132, these regions 130, 132 may be equal to one another.

In some examples, the first linear stitch 126 is formed in a first direction and the second linear stitch 128 is formed in a second direction, opposite the first direction such that the power ramping down regions 130, 132 extend in opposite directions. For example, in the example of a horizontal configuration, the welding tool may begin operation at a first location along the first and second components 122, 124 and form a generally horizontal weld in the first direction along the first component 122 and the second component 124 to join the components 122, 124 together. When the desired length of the first linear stitch 126 is reached, the welding tool gradually lessens the power of the welding tool until the power is off or at a desired lower power while still extending in the first direction, thereby forming the power ramping down region 130 of the first linear stitch 126. The welding tool then moves the desired vertical distance away from the first linear stitch 126 to create the second linear stitch 128. The welding tool begins the second linear stitch 128 in line with the end of the first linear stitch 128, not including the power ramping down region 130 such that the power ramping down region 130 extends past the second linear stitch 128. Then, the welding tool forms the second linear stich 128 by extending horizontally in the second direction, opposite the first direction, until the desired length of the second linear stitch 128 is reached. Once the desired length is reached, the welding tool again gradually lessens power of the welding tool until the power is off or at a desired lower power while still extending in the second direction, thereby forming the power ramping down region 132 of the second linear stitch 128.

Referring now to the examples shown in FIGS. 1-4, the weldment assembly 20, 120 is superior to a traditional staple weld, as the weldment assembly 20, 120 avoids heat accumulation and, thus, process instability in the arc regions of a staple weld. Moreover, the weld peak strength and absorbed energy increase significantly in the weldment assembly 20, 120 compared to staple welds, which offers enhanced load bearing and energy absorption capacity. Additionally, the weldment assembly 20, 120 has significantly less spatter as compared to a staple weld when dealing with coated materials. Moreover, with an appropriate interspacing between the first linear stitch 26, 126 and the second linear stitch 28, 128, as described herein, the weldment assembly 20, 120 can provide comparable or enhanced strength and energy absorption capacity compared to single staple welds. The appropriate interspacing between the first linear stitch 26, 126 and the second linear stitch 28, 128 also provides minimum heat affected zones overlapping between two stitches and still allows the resultant double stitch weld to be able to fit onto narrow components.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A weldment assembly comprising:
a first component; and
a second component configured to be coupled to the first component,
wherein the first component and the second component are coupled through a first linear stitch and a second linear stitch disposed parallel to the first linear stitch.

2. The weldment assembly of claim 1, wherein the first linear stitch and the second linear stitch are disposed approximately 5-20 mm apart.

3. The weldment assembly of claim 1, wherein the first linear stitch and the second linear stitch are disposed approximately 5-12.5 mm apart.

4. The weldment assembly of claim 1, wherein the first linear stitch and the second linear stitch are vertical stitches.

5. The weldment assembly of claim 1, wherein the first linear stitch and the second linear stitch are horizontal stitches.

6. The weldment assembly of claim 1, wherein the first linear stitch is linearly offset from the second linear stitch.

7. The weldment assembly of claim 1, wherein the first linear stitch is formed in a first direction and the second linear stitch is formed in a second direction, opposite the first direction.

8. The weldment assembly of claim 1, wherein a length of the second linear stitch is approximately 20-25 mm.

9. A vehicle incorporating the weldment assembly of claim 1.

10. A weldment assembly comprising:
a first component; and
a second component configured to be coupled to the first component,
wherein the first component and the second component are coupled through a first linear stitch and a second linear stitch,
wherein the first linear stitch extends in a first direction past the second linear stitch and the second linear stitch extends in a second direction past the first linear stitch, and
wherein the first direction is opposite the second direction.

11. The weldment assembly of claim 10, wherein the first linear stitch is formed in a first direction and the second linear stitch is formed in a second direction, opposite the first direction.

12. The weldment assembly of claim 10, wherein the first linear stitch and the second linear stitch are disposed approximately 5-12.5 mm apart.

13. The weldment assembly of claim 10, wherein the first linear stitch and the second linear stitch are vertical stitches.

14. The weldment assembly of claim 10, wherein the first linear stitch and the second linear stitch are horizontal stitches.

15. The weldment assembly of claim 10, wherein a length of the first linear stitch and a length of the second linear stitch are the same.

16. A vehicle incorporating the weldment assembly of claim 10.

17. A weldment assembly forming a component for a vehicle, the weldment assembly comprising:
a first component; and
a second component configured to be coupled to the first component,
wherein the first component and the second component are coupled through a first linear stitch and a second linear stitch disposed parallel to the first linear stich, with the first linear stitch and the second linear stitch disposed approximately 5-20 mm apart from one another,
wherein the first linear stitch is formed in a first direction and the second linear stitch is formed in a second direction, with the first direction being opposite the second direction, and
wherein the first component and the second component are coupled through a welding process, wherein the welding process is one or more of a fusion welding process, a laser beam welding process, an electron beam welding process, a solid-state welding process, a friction stir welding process, and an adhesive bonding process.

18. The weldment assembly of claim 17, wherein the first linear stitch and the second linear stitch are vertical stitches.

19. The weldment assembly of claim 17, wherein the first linear stitch and the second linear stitch are horizontal stitches.

20. A vehicle incorporating the weldment assembly of claim 17.
